(19) United States
(12) Patent Application Publication
(10) Pub. No.: US 2012/0245966 A1
(43) Pub. Date: Sep. 27, 2012

(54) PARKING MANAGEMENT SYSTEMS AND METHODS

(75) Inventor: Constance M. Volz, Arvada, CO (US)

(73) Assignee: Spire Parking, Denver, CO (US)

(21) Appl. No.: 13/071,128

(22) Filed: Mar. 24, 2011

(51) Int. Cl. G06Q 10/00; G06Q 30/00

(52) U.S. Cl. 705/5; 705/30; 705/14.49

(57) ABSTRACT

Various arrangements for managing one or more parking facilities using a parking management server are presented. The parking management server may permit day users, lessees, parking facility managers, and group tenants (e.g., entities renting groups of parking spaces) to lease, reserve, and manage parking spaces within parking facilities. User accounts maintained by the parking management server may permit parking fees to be paid remotely by users such that payment is not required to be made at a parking facility. Further, a user's vehicle may be identified using license plate recognition, such that additional hardware does not need to be added to a vehicle for a user account to be established.

### BACKGROUND

Parking a vehicle, especially in urban areas, can be time consuming and stressful. Two scenarios are typical: a vehicle that is parked in the same parking facility often (e.g., a vehicle parked by a person who works in an office building near the parking facility); and a vehicle that is parked infrequently or only once in a parking facility (e.g., a vehicle parked by a person to run an errand, visit a restaurant, or attend a sporting event in the vicinity of the parking facility). Each of these scenarios may result in various inefficiencies. The person parking the vehicle frequently may have a leased parking space that periodically, such as on nights, vacations, weekends, and holidays, remains vacant. The person parking the vehicle infrequently may have difficulty finding a parking facility with available parking spaces and/or finding a parking facility with acceptable parking rates.

### SUMMARY

Various methods, systems, devices, and apparatuses are described for managing one or more parking facilities. A method for managing parking facilities may comprise receiving, by a computer system, information regarding a plurality of parking facilities. The information regarding each parking facility may comprise a number of parking spaces in the parking facility; and a location of the parking facility. The method may comprise receiving, by the computer system, a vehicle identifier and identification of a user. The vehicle identifier may comprise a license plate number. The method may comprise creating, by the computer system, a user account linked with the vehicle identifier, the vehicle, and the user. The user account may be configured to link parking fees sustained by the vehicle at the plurality of parking facilities with the user account. The user account may be configured to permit the vehicle access to the plurality of parking facilities using the vehicle identifier wherein payment is not required to be made at the plurality of parking facilities.

Embodiments of the method may comprise transmitting, by the computer system, to a parking facility management computer system, parking utilization information for at least one parking facility of the plurality of parking facilities. The method may comprise receiving, by the computer system, from a remote computer system, a selection of a parking facility from the plurality from parking facilities. The selection may be linked with the user account. The method may comprise allocating, by the computer system, a parking space within the parking facility to the vehicle linked with the user account. Access to the parking facility may be regulated to reserve the parking space for the vehicle linked with the user account.

Embodiments of a method may comprise receiving, by the computer system, from the remote computer system, a selection of a zone within the parking facility, wherein allocating the parking space within the parking facility to the vehicle comprises allocating the parking space within the zone of the parking facility to the vehicle. The method may comprise storing, by the computer system, an indication of a lease agreement linked with the user account. The lease agreement may require reservation of a parking space at a parking facility of the plurality of parking facilities for the vehicle linked with the user account. The method may comprise receiving, by the computer system, a request to acquire access to the parking space for a period of time. The method may further comprise transmitting, by the computer system, to a mobile device linked with the user account, an offer to the user linked with the user account for the parking space for the period of time. The method may also comprise receiving, by the computer system, from the mobile device, a response to the offer. In some embodiments, the method may comprise transmitting, by the computer system, to a remote computer system, information identifying multiple available parking spaces in multiple parking facilities of the plurality of parking facilities.

In some embodiments, a method for controlling access to a parking facility is presented. The method may comprise receiving, by a computer system, from a parking facility access system of the parking facility, a vehicle identifier. The vehicle identifier may comprise a license plate number. The method may comprise determining, by the computer system, whether the vehicle identifier is linked with a user account. The method may comprise transmitting, by the computer system, an authorization to the parking facility access system. The authorization may permit the vehicle access to and from the parking facility without requiring payment to be made at the parking facility. The method may comprise updating, by the computer system, stored information regarding utilization of the parking facility.

In some embodiments, a system for managing a parking facility is presented. The system may comprise a computer system. The computer system may: receive information regarding a plurality of parking facilities, wherein the information for each parking facility comprises: a number of parking spaces; and a location. The computer system may receive, from a remote computer system, a vehicle identifier. The vehicle identifier may be sufficient to identify a vehicle. The computer system may create a user account linked with a user, the vehicle identifier, and the vehicle, wherein the user account is configured to: link parking fees sustained at the plurality of parking facilities with the user account, wherein the parking fees are sustained by the vehicle. The computer system may receive from a parking facility access system of a parking facility, the vehicle identifier. The computer system may determine whether the vehicle identifier is linked with a user account. The computer system may transmit an authorization to the parking facility access system. The authorization indicates that the vehicle may be permitted access to and from the parking facility without requiring payment to be made at the parking facility.

In some embodiments, the system further comprises the parking facility access system, comprising a license plate recognition system and an access control system. The parking facility access system may be configured to: transmit the vehicle identifier to the computer system. The vehicle identifier may comprise a license plate number; and the computer system may be remote from the parking facility access system. The parking facility access system may be configured to receive the authorization that indicates the vehicle is permitted to use the parking facility without requiring payment to be made at the parking facility. The parking facility access system may be configured to permit access, via the access control system, to and from the parking facility by the vehicle.

Embodiments of the system may comprise a parking facility management computer system, configured to: receive real time utilization information from the computer system; and provide lease information regarding a plurality of leases of parking spaces within the parking facility. Embodiments of the system may comprise a remote computer system, configured to request allocation of a parking space within the parking facility for the vehicle linked with the user account. Embodiments of the system may comprise a dynamic advertisement display, located at the parking facility, linked with the computer system, wherein the dynamic advertisement display is configured to display advertisements based on parking characteristics of the vehicle when the user is expected to be in the vicinity of the dynamic advertisement display. Embodiments of the system may comprise a mobile device, configured to: receive offers regarding a parking space leased by the user from the computer system; and transmit responses to the offers received to the computer system. Embodiments of the system may comprise electronic signage visible near an entrance to the parking facility, wherein the electronic signage is configured to display rates as received from the computer system.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a parking management system.

FIG. 2 illustrates another embodiment of a parking management system.

FIG. 3 illustrates an embodiment of a parking facility management dashboard.

FIG. 4 illustrates an embodiment of a parking system graphical user interface.

FIG. 5 illustrates another embodiment of a parking system graphical user interface.

FIG. 6 illustrates another embodiment of a parking system graphical user interface.

FIG. 7 illustrates an embodiment of a parking system graphical user interface.

FIG. 8 illustrates an embodiment of a parking facility access system.

FIG. 9 illustrates an embodiment of a method for creating a user account for a parking management system.

FIG. 10 illustrates an embodiment of a method for permitting use of a parking facility without requiring payment to be provided at the parking facility.

FIG. 11 illustrates an embodiment of a method for remotely reserving a parking space for a user.

FIG. 12 illustrates an embodiment of providing users in a queue the opportunity to acquire a parking space.

FIG. 12 illustrates an embodiment of a computer system.

### DETAILED DESCRIPTION

A computerized parking management system that allows entities, such as parking facility managers, (e.g., the person, company, or other entity that owns and/or manages the parking facility), parking space lessees, day users, and group lessees to manage the use of parking spaces within one or more parking facilities may allow for more efficient and more cost effective parking facility management. Real time or near real time accessibility of parking inventory may increase utilization of parking spaces and provide customers with the ability to view and select parking spaces which normally would not be accessible or would be difficult to find by the customer at a reasonable rate.

A computerized parking system may allow transactions that are typically performed at a parking facility to be either fully or partially completed remotely, such as via a web based interface. The use of such a remote interface may allow for functions, such as payment, parking space allocation, and/or leasing to be handled at a more convenient location and/or time. As such, the amount of time spent entering and/or exiting a parking facility may be decreased by not requiring a user (who is likely operating a vehicle) to render payment at either the time of entrance or exit from the parking facility. Speeding the entry and exit times to a parking facility may decrease the length of time vehicles spend idling. Further, a need for staffing at the parking facility may be decreased or eliminated. Moreover, tickets may not need to be issued to some or all users, thus decreasing the amount of paper and/or ink used. “Passback,” the use of one access device to let multiple vehicles into a parking facility, may also be decreased by using such a computerized parking system.

Using a computerized parking system may allow for a day user (a person who uses the parking facility once or more but does not have a rented, leased, or owned parking space within the parking facility) to park more efficiently. In some embodiments, such as via the web interface, a day user can reserve a parking space at a parking facility before physically arriving at the parking facility. As such, the day user may be assured that a parking space is available for the day user's vehicle upon arrival. Further, the day user may be permitted to reserve a parking space in a specific region of the parking facility possibly resulting in an adjustment of cost. For example, a reserved parking space near the entrance of the parking facility may cost more than a rooftop parking space. In some embodiments, a day user may be permitted to select a specific parking space.

A day user may also be presented with a listing and/or map of multiple parking facilities available through the computerized parking management system in a requested geographic area. From the list or map, the day user may select which parking facility the day user desires to use. The parking facilities may have varying cost structures. If a day user selects a parking facility that does not have space available, the day user may be directed to the next closest parking facility managed through the computerized parking management system.

Further, a day user (or lessee) may have their vehicle matched to parking space dimensions. For example, if a user specifies that their vehicle is long vehicle (e.g., an extended cab pickup truck), the size of the vehicle may be taken into account when locating an appropriate parking space. As such, parking space dimensions, garage clearance, and/or mobility of a vehicle (e.g., turning radius) may be used to identify which parking facilities or portions of parking facilities are accessible to the user's vehicle and/or which parking spaces within the parking facility are appropriate to use.

A computerized parking management system may allow the parking facility manager (herein referred to as “manager,” e.g., the person, company, or other entity that owns and/or manages the parking facility) to operate the parking facility more efficiently. The manager may be provided with a dashboard that displays real time utilization information about the parking facility. The dashboard may provide the manager with the ability to view information such as: information on leased parking spaces, number of day users, sell factors, turn factors, distribution of use by day users throughout the day, and the number of hours typically parked within parking facility. A dashboard report may be sent periodically to the manager in the form of a scheduled dashboard report. For example, via email once per day or week, a manager may receive a dashboard report with information related to utilization of one or more parking facilities linked with the manager.

Further, the manager may be able to electronically vary the rates for the parking facility by manipulating the rates presented to day users via the web interface and/or displayed electronically at the parking facility. For example, in anticipation of a large event in the vicinity of the parking facility, such as a parade, parking rates may be increased. The manager may also allow advertisements to be displayed at the parking facility. Based on the users of the parking facility, these advertisements may be adjusted to target specific users as they enter and/or exit the parking facility. These advertisements may also be based on the time of day, day of week, and/or other characteristics of the user parking in the parking facility. For example, a user parking in the facility at night or the weekend may be displayed advertisements for restaurants and movie theatres in the area, while a user parking during the day on a weekday may be displayed advertisements directed to business-oriented services.

A computerized parking management system may also allow the parking facility manager to increase the utilization of the parking facility, and thus, possibly increase profit margins. For example, the parking facility manager may be able to employ an oversell factor. The computerized parking management system may provide a manager with the ability to “lease back” parking spaces from lessees (who lease, rent, own, or otherwise hold the rights to a parking space within the parking facility). As an example, if a nighttime sporting event is occurring near the parking facility, many spaces leased by professionals who work in the area during the day may typically remain vacant. The computerized parking management system may provide the manager with the ability to provide these lessees with an offer to lease back a parking space for a period of time (such as an amount of money for the time period of the sporting event). As such, if the lessee accepts the offer, the lessee would gain the consideration of the offer and the manager would gain the ability to sell another parking space (presumably for more money than the offer) for during the sporting event.

A computerized parking management system may also provide building tenants with efficient parking opportunities. A tenant (e.g., a corporation, company, or other entity that frequently requires parking spaces within the parking facility) may validate parking for guests parked in a parking facility in the vicinity of the tenant. Typically, this involves providing the guest with a coupon, stamp, or other physical evidence of validation that needs to be produced upon exit from the parking facility. The building tenant may instead provide the computerized parking management system with a vehicle identifier (such as a license plate number) of the guest's vehicle. Upon attempting to exit the parking facility, the guest may be granted egress without any further interaction with the parking access system of the parking facility by the guest.

A computerized parking management system may also provide a group tenant that leases a group of parking spaces with efficient parking management opportunities. The group tenant may, such as through a web interface, manage which users and/or vehicles are permitted access to the parking facility and/or parking spaces linked with the tenant. For example, an employee that is terminated may be immediately blocked from entering the parking facility by the group tenant by using a web interface.

A computerized parking management system may also provide potential lessees an efficient interface to queue for an available parking space. As parking spaces become available for lease, the computerized parking management system may automatically contact previously-identified potential lessees present in a queue. The space may then be allocated to one of the potential lessees based on offers and responses, possibly exchanged via text message.

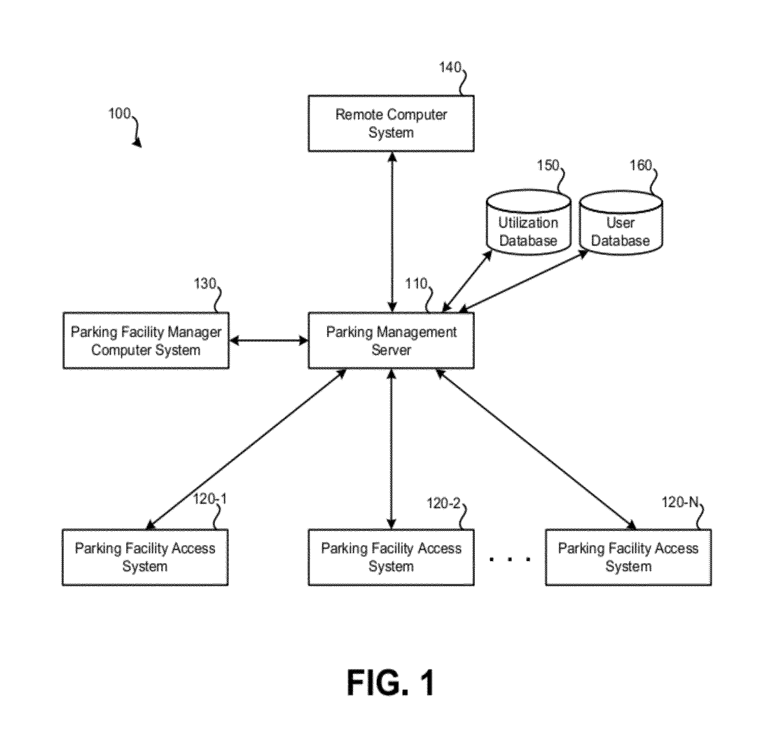

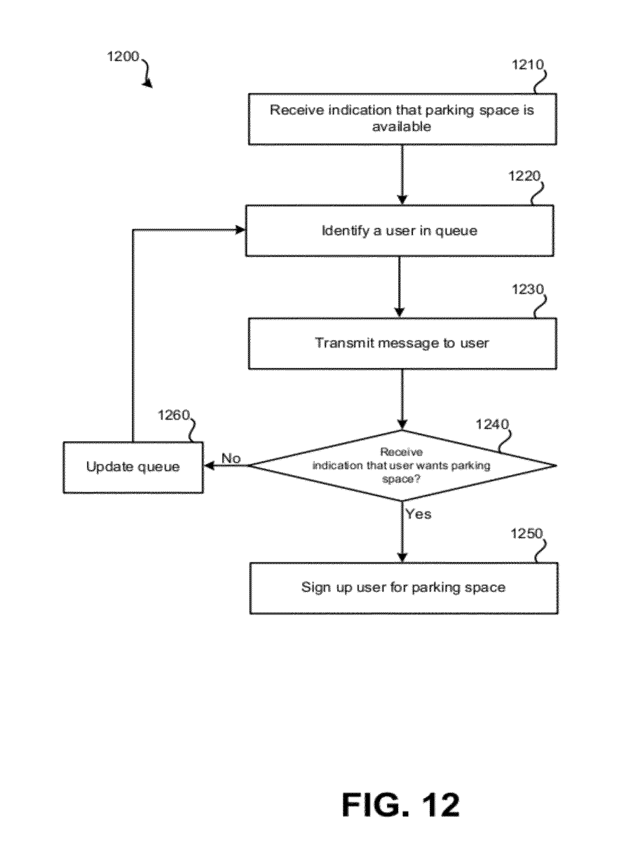

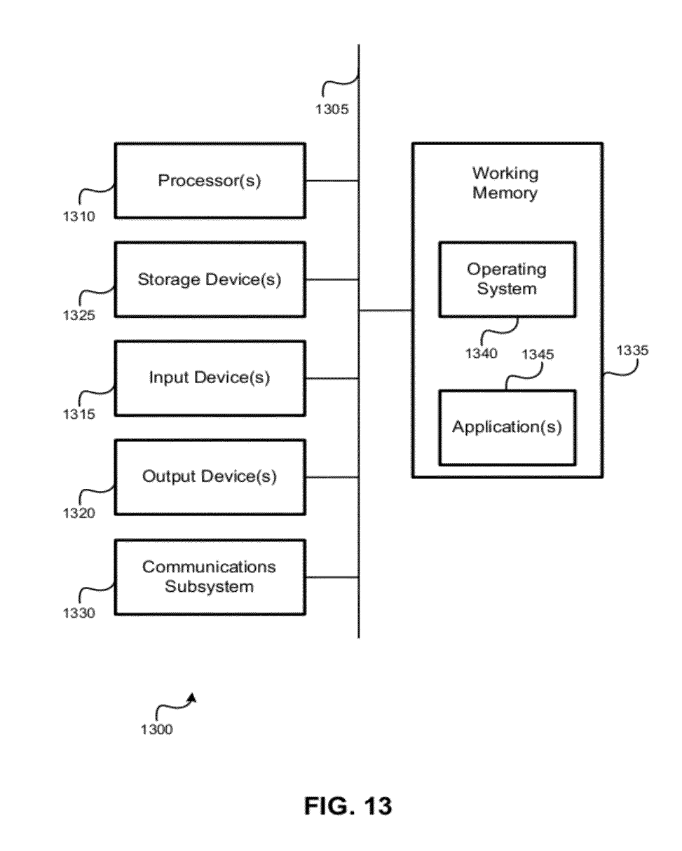

FIG. 1 illustrates an embodiment of parking management system 100. Parking management system 100 may include: parking management server 110, parking facility access systems 120, parking facility management computer system 130, and remote computer system 140. Each of these components may include a computer system, such as computer system 1200 of FIG. 12. Parking management system 100 may be used to manage parking at one or more parking facilities.

A parking facility may be any type of parking area where a vehicle is permitted to park. A fee may be required to be paid for use of the parking facility according to some time period (such as per hour, per day, or per month). Access to a parking facility may be controlled such that only vehicles that have paid, have billing information on file, or are expected to pay, are allowed entrance to and/or egress from the parking facility. Parking facilities include parking garages (e.g., an airport parking garage, a parking garage within an office building, a stand alone parking garage) and surface lots, and/or combinations thereof. Other forms of parking facilities may also be possible.

Parking management server 110 may represent a computer system that is in communication with parking facility access systems 120, which are located at one or more parking facilities. Parking management server 110 may be operated by the same entity that owners and/or manages some or all of these parking facilities. In some embodiments, parking management server 110 is operated by a third-party entity, such as by an entity that contracts with parking facility owners and/or managers to handle billing, leasing, and general access to the parking facility.

Parking management server 110 may communicate with one or more parking facility access systems, such as parking facility access systems 120. Parking facility access system 120-1 may be located at one parking facility while parking facility access system 120-2 is located at another parking facility geographically separated from parking facility access system 120-1. As such, parking facility access systems 120-1 and 120-2 may be located at parking facilities that are within the same city or are separated by significant distances, such as parking facilities located on opposite coasts. Parking facility access system 120-N represents that parking management server 110 may be in communication with a varying number of parking facility access systems. While three parking facility access systems 120 are illustrated as part of parking management system 100 in the illustrated embodiment, it should be understood that one, two, four, or more parking facility access systems may be in communication with parking management server 110 in other embodiments.

Parking management server 110 may exchange information with each of parking facility access systems 120. When a vehicle attempts to enter and/or exit from a parking facility, an associated parking facility access system, such as parking facility access system 120-1, may transmit information to parking management server 110. Parking facility access system 120-1 may transmit a vehicle identifier that serves to identify the vehicle to parking management server 110. Based upon a response from parking management server 110, parking facility access system 120-1 may perform actions such as: permit entrance to the parking facility, deny access to the parking facility, require payment before entrance to the parking facility, require payment before exit from the parking facility, allow entrance and/or exit without payment being made at the parking facility, and/or display advertisements directed to the user.

When a vehicle enters and/or exits from a parking facility, such as the parking facility associated with parking facility access systems 120-1, various information may be updated at parking management server 110. For example, parking server system 110 may be in communication with one or more databases, such as utilization database 150 and user database 160. Utilization database 150 may be used to store information regarding the current and past utilization of the parking facilities associated with parking facility access systems 120. Utilization database 150 may also store information regarding patterns and trends related to one or more parking facilities. When a vehicle enters and/or exits the parking facility associated with parking facility access system 120-1, utilization database 150 may be updated to reflect the activity by the vehicle. User database 160 may be used to store information regarding users that have accounts with parking management server 110. When a user attempts to access a parking facility, the corresponding parking facility access system may transmit a vehicle identifier to parking management server 110. Parking management server 110 may then determine whether the vehicle identifier matches a vehicle linked with a user having a record in user database 160. Based upon the result, parking management server 110 may respond to the parking facility access system with instructions indicating how to handle the user and her associated vehicle.

A vehicle identifier may be an identifier that is sufficient to distinguish a vehicle from other vehicles. One possible vehicle identifier can include a license plate number. The license plate number may be used in conjunction with other license plate information, such as the name of the state (or other governmental institution) that issued the license plate. Use of the license plate as the vehicle identifier has an advantage that no additional hardware may need to be installed on the vehicle. Other forms of vehicle identifiers can include RFID. Use of RFID may require that a user install an RFID tag on the vehicle. Still other forms of vehicle identifiers may be used, for example a wireless platform with receivers mounted in a parking facility may receive position information from wireless sensors present on vehicles. Such an arrangement may be useful in not only determining the vehicle entering and exiting a parking facility, but where in the parking facility the vehicle has parked and has driven. For example, based on the location of the sensor, it may be determined what parking space a vehicle is in. In some embodiments, GPS may be used to determine the location of a vehicle.

Parking management server 110 may be in communication with parking facility manager computer system 130. Parking facility manager computer system 130 may be operated by a manager of one or more parking facilities. While only one parking facility manager computer system 130 is illustrated as part of parking management system 100, it should be understood that one or more additional parking facility manager computer systems may communicate with parking management server 110, such as a parking facility manager computer system for each parking facility that has an associated parking facility access system in communication with parking management server 110. Users may be granted parking access to multiple parking facilities in communication with parking management server 110. For example, a user may have a monthly rate to use multiple parking facilities. For example, consider a sales executive that regularly uses multiple parking facilities throughout a metro area. The executive may be able to get a monthly fee that covers parking in multiple parking facilities in communication with parking management server 110. Such a user may select a “home” garage, but may receive a favorable rate at other facilities linked with parking management server 110.

Parking facility manager computer system 130 may present a parking facility manager with a dashboard displaying information about the parking facility associated with the parking facility manager computer system. The dashboard may be a software application executed by parking facility manager computer system 130 that receives information from parking management server 110. In some embodiments, the dashboard is a web-based application, which may be accessible by parking facility manager computer system 130 via a web browser. The information displayed by the dashboard may be in real-time (e.g., current within the past minute or hour) or near real-time (e.g., current within the previous day). The information displayed by the dashboard at parking facility manager computer system 130 may include information such as the utilization of the parking facility, the status of parking space leases, the rate structure, and use by day users. The parking facility manager may elect to receive the dashboard reports at specific dates and times. This may be set up through a report scheduler accessible via the parking facility manager computer system.

Parking facility manager computer system 130 may permit the manager to modify characteristics of the parking facility as stored by parking management server 110. For example, a manager may adjust the number of parking spaces available for day use and/or leases. The manager may also adjust the rate structure of the parking facility. If additional parking spaces are added to the parking facility (such as through a physical addition or parking space line repainting) the number of parking spaces may be adjusted at parking management server 110. Such additional spaces may include motorcycle, bicycle, and vehicle storage parking areas (e.g., for RV's). The parking facility manager may use this information to measure and/or calculate parking utilization space availability, lease differentials, turn factors, and oversell factor percentages.

Parking facility manager computer system 130 may also permit a manager to contact various users (such as lessees of parking spaces) of the parking facility linked with parking facility manager computer system 130. Parking management server 110, in user database 160, may store various contact data for users, such as e-mail addresses and phone numbers. If a parking facility has some number of leased parking spaces, the manager of the parking facility may occasionally wish to reacquire rights to at least some of those parking spaces for a period of time. As such, using parking facility manager computer system 130, the manager may be able to request that parking management server 110 contact some or all of the users having a leased parking space within the parking facility and present those lessees with an offer for use of their leased parking spaces. For example, the offer may include an amount of money or a lease discount.

The manager may attempt to reacquire rights to the parking spaces for periods of time when the parking spaces are typically unused. For example, if the parking facility is located in or near an office building, the leased parking spaces may typically only be used during business hours. If a special event, such as a parade or sporting event, is occurring outside of business hours in the area of the parking facility, the manager may wish to require the rights to the leased parking spaces such that they can be resold to persons attending the special event. In such arrangements, the manager may attempt to resell the parking spaces for a greater amount of value than the manager used to reacquire the parking spaces from the lessees.

Parking management server 110 may also be in communication with a remote computer system 140. While parking management system 100 illustrates one remote computer system in communication with parking management server 110, it should be understood that multiple remote computer systems can be in communication with parking management server 110. For example, each user may use a home computer system, or other electronic device, to communicate with parking management server 110. Additionally, day users, including potential users that have not yet registered with parking management server 110, may communicate with parking management server 110 using a remote computer system.

An application that is executed locally by remote computer system 140 or a web-based application (which may be executed through a web browser) may allow users to interact with parking management server 110. Referring to users that are lessees, the users may be able to manage their leases. For example, by interacting with parking management server 110, the users may be able to make payments, renew their leases, and/or terminate their leases. If an offer has been made by a manager of a parking facility to lease back a parking space, users may be able to respond through remote computer system 140 as to whether they accept the offer made by the manager of the parking facility.

Day users may also interact with parking management server 110 via remote computer system 140 using a locally installed application that communicates with parking management server 110 or a web-based application, which may be executed through a web browser. A person who has never interacted with parking management server 110 may communicate with parking management server 110 via remote computer system 140 to register as a user. This may involve the person providing various information such as: the person's name, the person's address, identifier's of one or more vehicles linked with the person, and/or billing information (e.g., a bank account number, a debit card number, a credit card number, a stored value card number, a gift card number). This information may be stored by parking management server 110 in user database 160. As such, when the person enters a parking facility, such as the parking facility associated with parking facility access system 120-1, parking facility access system 120-1 may transmit the vehicle identifier of the person's vehicle to parking management server 110. Parking management server 110 may determine the vehicle identifier is linked with the user using user database 160. Parking fees incurred by the person at the parking facility associated with parking facility access system 120-1 may be charged to an account of the person stored by parking management sever 110.

Additionally, remote computer system 140 may be used by day users to reserve a parking space in the parking facility prior to the day user driving her vehicle to the parking facility. As such, the day user may be assured that a parking space will be available for the day user's vehicle when she arrives at the parking facility. The remote computer system 140 may display a list and/or map of parking facilities linked with parking management server 110 in the region indicated by the day user in which she desires to park. Using remote computer system 140, the day user may select a parking facility at which she wishes to park her vehicle. Parking management server 110 may then reserve a parking space for the day user. As such, the parking facility access system associated with the parking facility the day user has selected may be regulated by the parking management server 110 such that at least one parking space remains empty until the day user's vehicle has entered the parking facility.

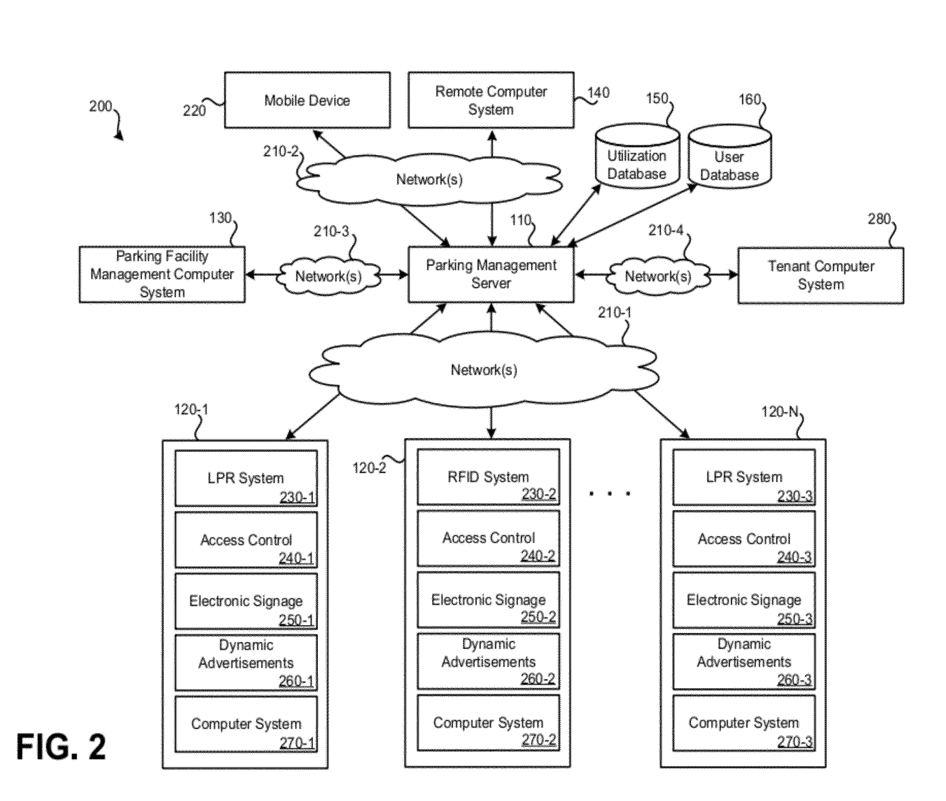

FIG. 2 illustrates another embodiment of a parking management system 200. Parking management system 200 may represent parking management system 100 of FIG. 1 or may represent some other parking management system. Parking management system 200 may include: parking management server 110, parking facility access systems 120, parking facility management computer system 130, remote computer system 140, utilization database 150, user database 160, networks 210, mobile device 220, and group tenant computer system 280.

Parking management server 110 may communicate with parking facility access systems 120, parking facility management computer system 130, remote computer system 140, mobile device 220, and group tenant computer system 280 via one or more networks 210. Networks 210 may include one or more private networks, such as a corporate intranet, and/or one or more public networks, such as the Internet. Further, networks 210 may include one or more wireless networks, such as a cellular network, to communicate with mobile device 220. Utilization database 150 and user database 160 are illustrated in parking management system 200 as in direct communication with parking management server 110. It should be understood that in some embodiments, utilization database 150 and user database 160 may also communicate via networks 210 with parking management server 110.

FIG. 2 illustrates various components of parking facility access systems 120. Parking facility access system 120-1 includes: license plate recognition (LPR) system 230-1, access control system 240-1, electronic signage 250-1, dynamic advertisements 260-1, and computer system 270-1. LPR system 230-1 may detect the license plate number and/or state of vehicles entering and/or exiting the parking facility at which parking facility access system 120-1 is located. As such, license plate numbers may be used as vehicle identifiers by parking facility access system 120-1.

Access control system 240-1 may prevent unauthorized entrance and/or exit from the parking facility. For example, access control system 240-1 may include a gate that blocks entrance to and/or exit from the parking facility and is moved when access to or from the parking facility is granted (such as by parking management server 110). In some embodiments, access control system 240-1 may be a retractable spike strip or some other physical device that restricts access to and from the parking facility. In some embodiments, no physical device is used to prevent entrance and/or egress from the parking facility. Access control system 240-1 may also collect payment from persons at the parking facility. For example, access control system 240-1 may include a pay station capable of reading transaction cards (such as credit cards, debit cards, stored value cards) and/or receiving cash. Such a pay station may be located at the exit of the parking facility. Payments at the parking facility (such as using the pay station) may be required by persons who have not created an account with parking management server 110. Persons who have not created an account may be directed to parking spaces in a zone of the garage designated for non-network users. For example, an electronic sign may indicate that the person is to proceed with her vehicle to level 5. One or more sensors within the parking facility may determine placement of the person's vehicle and transmit related data to the parking management server. An LPR system may still detect and store information on the person's vehicle license plate. The person may be directed to set up an account before leaving the parking facility. For example, a sign may provide a link for the person to use from a mobile device to create an account. In some embodiments, if parking management server 110 does not recognize a vehicle identifier of a vehicle, parking management server 110 may not be able to bill the fees for parking to a user account present in user database 160. As such, payment may be required to be made to access control system 240-1 before entrance or exit of the person's vehicle from the parking facility.

Access control system 240-1 may prevent vehicles from entrance to a parking facility based on the vehicle's characteristics. For example, if the size, weight, make, model, and/or year of the vehicle (either as detected or noted in the associated user account) does not meet certain conditions, the vehicle may be denied access to the parking facility. For example, certain large models of trucks may not be able to fit in some or all of the parking spaces within the parking facility or may be unable to negotiate certain turns within the parking facility due to the dimensions of the parking facility. In some embodiments, based on the vehicle's characteristics, the user may be directed to drive to a particular zone of the parking facility for parking.

Electronic signage 250-1 may be used to display parking rates at the parking facility to potential users. For instance, a manager using parking facility management computer system 130 may provide an indication to parking management server 110 that for a certain period of time parking rates are to be raised at the parking facility linked with parking facility management computer system 130. As such, the rates displayed at the parking facility by electronic signage 250-1 may be adjusted to reflect the new rates. The ability to dynamically vary pricing at the parking facility via the electronic signage may especially be useful when a high demand of parking in the vicinity of the parking facility is expected, such as during a special event. Electronic signage 250-1 may reflect information updates from the parking facility management computer server. Such information may include parking rates, emergency alters, advertisements, garage status (e.g., open or full), LEED certification, and wayfinding directions.

Dynamic advertisements 260-1 may be electronic displays, similar to electronic signage 250-1, that display advertisements based on various factors, such as the characteristics of a user entering and/or exiting the parking facility, the time of day, day of week, the time of year, etc. As an example, if the lessee is entering the parking facility at which parking facility access system 120-1 is located, an advertisement may be displayed to the lessee that is generally directed to someone who works in the area, such as a nearby copy shop. A different advertisement may be displayed to a day user that is arriving at the parking facility at night, such as an advertisement for a nearby restaurant. Further, if a user has provided personal information to parking management server 110, such as via remote computer system 140, this information may be used to specifically tailor advertisements to the user when the user is expected to be present in and around the parking facility, such as when the user is entering and/or exiting the parking facility in the user's vehicle. One particular form of advertising that may be effective could be a business entity using the dynamic advertisements 260-1 to indicate that the business has paid for (some or all of) the user's parking fees. As such, the user may exit the parking facility with the associated parking fees being charged to the business entity.

Computer system 270-1 may be in communication with the various other components of parking facility access system 220-1. For example, computer system 270-1 may receive license plate numbers from LPR system 230-1. Computer system 270-1 may communicate with parking management server 110. Based on communication with parking management server 110, computer system 270-1 may instruct access control system 240-1 to allow a vehicle entrance and/or egress from the parking facility. The computer system 270-1 may also instruct access control system 240-1 that payment is to be collected prior to permitting the vehicle to enter or exit. Users may access the parking management network to view their account parking facility access status (e.g., accepted or denied).

Parking facility access system 120-2 may contain at least some components similar to parking facility access system 120-1. However, rather than having LPR system 230-1, parking facility access system 120-2 has RFID system 230-2. RFID system 230-2, rather than using license plate numbers, may use RFID tags as vehicle identifiers. As such, an identifier linked with an RFID tag present in a vehicle may be stored by parking management server 110 in a database, such as user database 160. If an RFID tag is not present to identify the vehicle at the parking facility of parking facility access system 120-2, payment may be required to be made to access control system 240-2 before entrance and/or egress from the parking facility of parking facility access system 120-2 is permitted. While parking facility access system 120-1 has only LPR system 230-1 and parking facility access system 120-2 is illustrated as having only RFID system 230-2 in parking facility management system 200, in some embodiments, both an LPR system and an RFID system may be present in the same parking facility access system.

Mobile devices, such as mobile device 220, may be operated by a user, such as a lessee or a day user, and may be in communication with parking management server 110. Mobile device 220 may be a cellular phone. For example, parking management server 110 may store phone numbers related to users in user database 160. When parking management server 110 needs to communicate with a lessee or a day user, messages may be sent to a mobile device linked with the lessee or the day user. For example, if a manager, via parking facility management computer system 130, makes an offer to temporarily reacquire one or more leased parking spaces, parking management server 110 may send out one or more messages (such as text messages) to mobile devices of lessees. The messages may include details of the offer made by the manager. From their mobile devices, lessees may be able to respond to either accept or reject the offer. If the offer is rejected, parking management server 110 may contact additional lessees in attempts to reacquire the number of parking spaces desired by the manager.

If a day user, via either remote computer system 140 or mobile device 220, requests a parking space at a parking facility be reserved, information regarding that parking facility may be transmitted to a mobile device linked with the day user. For instance, directions to the parking facility and/or weather information may be transmitted to the mobile device. Digital mapping of the facility and garage may give access to customers to view directions to and from the parking facility (from beginning and ending points) alone with turn-by-turn directions in the garage that take them to a designated parking space. A map of the inside of the parking facility may also be transmitted to the mobile device. If the user has been permitted to select a particular parking space or zone with the parking facility, the map may display the location of the parking space or zone and how to get to the parking space or zone from the parking facility's entrance. Additionally, advertisements, such as in the form of offers for various restaurants or stores in the area of the parking facility, may be transmitted to mobile device of the day user.

Mobile device 220 may also be used to receive messages regarding charges to the user's account. Users may look at their statement months later and forget if they parked at the locations specified on their account statement. As such, a “receipt” may be used for some or all parking facility fees that are paid from the account. For example, after a user leaves a parking facility she may receive a text or email confirmation stating “Thank you for parking at “XYZ” location, your parking fee is $10.00 and will be charge to your account”. Reminders for fees paid may also be displayed when the user logs into her account from a remote computer system. This may help decrease disputes over parking charges.

While only mobile device 220 is illustrated in FIG. 2, it should be understood that parking management server 110 may be in communication with many other mobile devices. For example, for some or all of the users present in user database 160, parking management server 110 may periodically be in communication with a mobile device associated with each user.

Mobile device 220 and remote computer system 140 may also be used to receive other communication. For example, parking alerts (e.g., parking facility closures, construction notices, security alters, reminders, changes in lease terms) may be transmitted to users. Additionally, users may be notified of violations, such as speeding within the parking facility. Fines may be assessed against a user's user account. In some embodiments, a parking management server can automatically assess fines for parking facility rule violations. Similarly, a user may use mobile device 220 and/or remote computer system 140 to report incidents (e.g., vehicle accidents) within the parking facility to the parking facility's management. Mobile device 220 may also be used to receive information from an attendant at a parking facility where a user's vehicle is parked. For example, if the attendant notes the vehicle has its lights left on, the attendant may be able to use the vehicle identifier (e.g., license plate number) to identify the vehicle and indicate the vehicle has its lights on. The parking management server may determine a user account and/or mobile device linked with the vehicle identifier and send a text message, email, voice message, or some other indication to the user to inform her about her vehicle. Such an arrangement may not require the user's person information (e.g., mobile device phone number) to be revealed to the attendant. Rather, the parking management server determines the appropriate mobile device phone number to use to contact the user linked with the vehicle identified by the attendant.

Parking management server 110 may also be in communication with one or more group tenant computer systems, such as group tenant computer system 280. Group tenant computer system 280 may be used by a local building occupant (or some other entity) that has rights (such as leases) to a group of parking spaces within a parking facility. The group tenant may be responsible for payment to the parking facility manager for the use of the parking spaces rather than the individual users of the parking spaces. For example, a group tenant may be a corporation that has an office near a parking facility, and has acquired a number of parking spaces for the corporation's employees. Group tenant computer system 280 may permit the group tenant to interact with parking management server 110 via a software application locally installed on group tenant computer system 280 or via a web-based application (which may be executed through a web browser).

Using group tenant computer system 280, a group tenant may be able to allocate its leased parking spaces as desired. For example, the group tenant may be able to allocate its parking spaces to particular employees, such as by having each employee provide account information and provide a vehicle identifier and/or usernames of employees. Also, the group tenant may be able to pay for the leases on its parking spaces, acquire additional parking spaces, and/or end of the lease of parking spaces. Additionally, via group tenant computer system 280, a group tenant may be able to validate parking for a guest parked in the parking facility where the group tenant has a group of parking spaces, or any other parking facility in communication with parking management server 110. For example, if a group tenant wishes to validate parking for a guest, the group tenant, via group tenant computer system 280, may provide a vehicle identifier of the guest's vehicle, such as the guest's vehicle's license plate number. Upon the guests and the guest's vehicle entering and/or exiting the parking facility, no payment may be required from the guest and the access control system of the parking facility access system may not obstruct the guest's vehicle because the group tenant has validated the guest's parking.

While only group tenant computer system 280 is illustrated in FIG. 2, it should be understood that parking management server 110 may be in communication with many other group tenant computer systems. For example, for each group tenant that has a group of parking spaces leased in a parking facility or desires the ability to validate parking for guests, parking management server 110 may at least periodically be in communication with an associated tenant computer system. Further, to validate parking, a business, corporation, person, or other entity may not need to be leasing a group of parking spaces. Rather, the entity may have an account with the parking management server 110 that allows the entity to validate parking of other vehicles and pay for such associated parking fees.

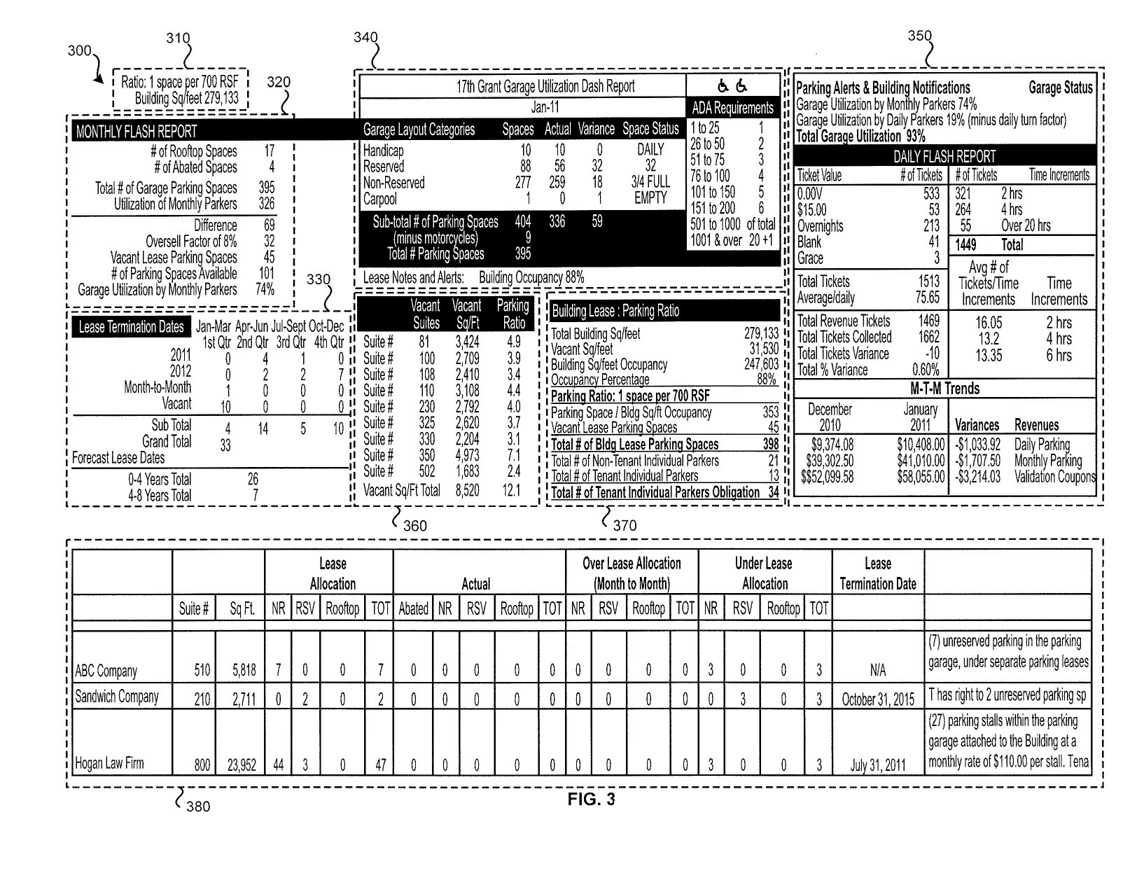

FIG. 3 illustrates an embodiment of a parking facility management dashboard 300. Such a parking facility management dashboard may be presented to an owner and/or manager of a parking facility via a parking facility management computer system, such as parking facility management computer system 130 of FIGS. 1 and 2. Parking facility management dashboard 300 may be presented in either real-time or near real-time.

Parking facility management dashboard 300 may present various parking facility and associated building statistics to a manager and/or owner of a parking facility. If a parking facility is a stand-alone parking facility, no associated building statistics may be provided. In the illustrated embodiment of parking facility management dashboard 300, the parking facility is part of (or associated with) an office building (e.g., is below the office building). In region 310 of parking facility management dashboard 300, a display of a building's total square feet and the number of parking spaces in the parking facility per rentable square feet (RSF) is provided.

In region 320 of parking facility management dashboard 300, a monthly report may be presented detailing the utilization of the parking facility (e.g., the number of vehicles being parked in the parking facility). This monthly report may break down the utilization according to different types of parking spaces available within the parking facility. For example, the parking spaces may be broken down according to various zones, including: rooftop spaces (e.g., on the roof of the parking facility where the vehicle may be uncovered), surface spaces (e.g., in a surface parking lot), reserved spaces (e.g., numbered spaces assigned to a particular person or entity) and a non-reserved spaces (e.g., parking spaces not assigned to a particular person or entity). This monthly report may provide the difference between the number of parking spaces available in the garage and the number of parking spaces leased, rented, or otherwise assigned to monthly parkers (e.g., lessees). Information may also be displayed regarding an oversell factor, the number of parking spaces available for lease that are vacant, and the percentage of parking spaces that are utilized by lessees.

In region 330 of parking facility management dashboard 300, various information regarding lease termination dates may be provided. A breakdown per quarter and per year of when leases terminate may be provided. Also, forecast of the lease termination dates broken down by year, or multiyear periods may also be provided.

In region 340 of parking facility management dashboard 300, real-time and/or near real-time information may be provided for various parking space categories within the parking facility. For example, referring to region 340, parking space categories of handicapped, reserved, non-reserved, carpool, large vehicle designation, visitor parking area, and motorcycle are broken out. The total number of spaces available in each category may be displayed, “actual” may represent the number of parking spaces occupied or otherwise unavailable. The variance between the total number of spaces present in the garage and the actual in each category is also displayed. Also, a status for each category of spaces is displayed. This space may indicate approximately how many of the spaces within each category are filled. Also, in region 340, a display indicating ADA (Americans with Disabilities Act) requirements. Based on the total number of parking spaces in the parking facility, the number of required handicapped parking spots may be identified.

In region 350 of parking facility management dashboard 300, information regarding parking facility utilization by lessees and day users may be presented. For example, the number of transactions may be broken down according to value, time increments, number of transactions per time increments, number of transactions issued on average per day, the total number of transactions performed, number of transactions that resulted in revenue, number of transactions that did not result in revenue, the number of transactions initiated, number of transactions collected on, and the difference between the number of transactions initialed and collected on. Additionally, information regarding the amount of money earned from day users, lessees, and validated users (e.g., validated by a tenant or have a coupon that can be redeemed for parking) may also be presented in region 350.

In region 360 of parking facility management dashboard 300, information related to building occupancy may be displayed. An embodiment of parking facility management dashboard 300, the amount of vacant square feet per suite, and the associated parking ratio is displayed. As such, in the illustrated embodiment, for approximately every 700 vacant square feet, a parking space is associated with the respective suite.

In region 370 of parking facility management dashboard 300, information related to leases and parking ratios may be displayed. This region of the parking facility management dashboard 300 may include information on the building's total square feet, the building's vacant square feet, the building's square-foot occupancy, and the occupancy percentage of the building. Assuming one parking space per 700 rentable square feet, the parking space per building's square-foot occupancy in the vacant lease parking spaces is also displayed. The total number of building lease parking spaces may be displayed. Further, the total number of non-tenant individual parkers (e.g., persons leasing a space that are not associated with a building tenant), the total number of tenant individual parkers (e.g., persons leasing the space that are associated with leased, rented, or owned space within the building), and the total number of individual parkers' obligations (e.g., the total number of tenant and non-tenant individual parkers) may be displayed.

In region 380 of parking facility management dashboard 300, information related to leases may be displayed. In this region, each tenant leasing a group of parking spaces may be listed. Linked with each tenant may be information in the following categories: suite number, square footage of the suite, number of non-reserved parking spaces, number of reserved parking spaces, number of rooftop parking spaces, and total number of parking spaces allocated to the tenant. Additionally, linked with each tenant may also be the following information: in actual number of repeated parking spaces, then actual number of non-reserved parking spaces, the lease rate structure, the lease to parking space ratio, lease renewal information and actual number of reserved parking spaces, and actual number of rooftop parking spaces, and a total number of actual parking spaces. Further, a number of non-reserved parking spaces, reserved parking spaces, rooftop parking spaces and the total number of parking spaces over a lease allocation on a month-to-month basis may be displayed for each tenant. Also displayed may be a number of parking spaces under the lease allocation for each category of parking spaces. A termination date for each release may also be listed for each tenant. Finally, various comments and notes may be listed for some or all of the tenants.

Parking facility management dashboard 300 displays various pieces of information which may be useful to a manager of a parking facility. Parking facility management dashboard 300 may permit the owner to modify such information. It should be understood that the information displayed in parking facility management dashboard 300 is not intended to be limiting. Similar information may be displayed in a different format. In some embodiments, less information or additional information may also be displayed via parking facility management dashboard 300. In some embodiments, the manager may be permitted to modify the presentation of parking facility management dashboard 300.

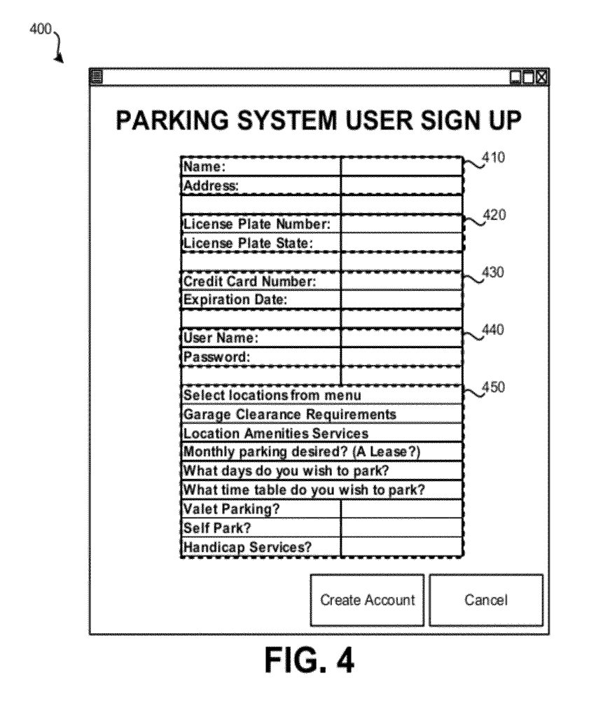

FIG. 4 illustrates an embodiment of a parking system graphical user interface 400. Parking system graphical user interface 400 may be presented to a person who wishes to interact with parking management server 110. Parking system graphical user interface 400 may be presented to a user via a remote computer system such as remote computer system 140 of FIGS. 1 and 2 and/or a mobile device, such as mobile device 220 of FIG. 2. Graphical user interface 400 may collect a name and address for a person wishing to interact with parking management server 110 in region 410. Additionally, for parking at a parking facility that utilizes license plate recognition technology, the license plate number and state of the user's vehicle may be collected in region 420. If the user wishes to have multiple vehicles associated with her account, the user may be presented with the opportunity to provide additional license plate numbers. Additional vehicle information that may be required to be provided by the user can include the make, model, year, and color of the user's vehicle or vehicles.

Billing information may also be collected from the user via the parking system graphical user interface 400 in region 430. The user may have the ability to provide bank account information, debit card information, credit card information, checking account information, stored value account information, and/or gift card information. In the embodiment of FIG. 4, the user has selected to provide credit card information. As such, once the user has begun to use parking facilities linked with parking management server 110, parking fees may be charged to the credit card account links with the credit card number provided by the user. Additional billing information may include employer contact information, and e-mail address, a cell phone number, and/or an alternative phone number. Via region 440, the user may also create a username and password such that the user can log into his account at a later time.

Other information may also be gathered about the user via region 450. For example, if a parking facility that uses RFID tags to identify vehicles is to be used, the user may provide an identifier linked with the RFID tag present in the user's vehicle. The user may also be able to specify whether he wishes to receive various notifications, such as for information related to the parking facility and/or geographic area where the user intends to park. The user may also be able to specify whether the user is adjusted in various amenities, such as carwashes, vehicle detailing, service repair, roadside emergency services, etc. The user may also be prompted to provide a preferred geographic area which may include specifying a state, city, and/or parking facility. The user may also specify a preference for a type of parking, such as non-reserved, reserved, rooftop, surface, handicapped, etc. The user may also be prompted to provide additional information if the user is related to (e.g., an employee of) a building tenant that has a relationship with one or more parking facilities. If so, the user may be provided with preferential parking rates for one or more of the parking facilities. The user may be required to provide the user's driver's license number, the user's driver's license expiration date, and the state that issued the driver's license.

Other information which may be used to assist a user in selecting a parking facility may also be collected via region 450. Information regarding the amount of clearance required by the vehicles of the user may be collected, what days of the week the user is likely to want to park (e.g., weekdays only, weekends only), what time of day the user is likely to want to park (e.g., day, night), whether valet parking is desired, whether self parking is desired, and/or if any handicap services (e.g., a van accessible parking space, elevator) are required.

Graphical user interface may permit a user (or person who has not yet registered) to purchase gift cards and/or receive on-line gift cards from other users. The amount may be transferred between accounts of the sender and recipient. For non-account holders, gift cards may be purchase at any retail stores and given to anyone who may wish to park at any of the parking facilities linked with the parking management server. The store gift card may have instructions on how to redeem purchase either by accessing the parking network system to set up an account and/or by a current user who enters the gift card identification number via graphical user interface 400. The amount of the gift card may be reflected on the user's billing account summary.

The illustrated embodiment of parking system graphical user interface 400 of FIG. 4 is merely an example. The format in which information is collected from a user may vary. Multiple graphical user interfaces may be used to collect similar information. In some embodiments, additional or less information is collected from users and persons enrolling as users.

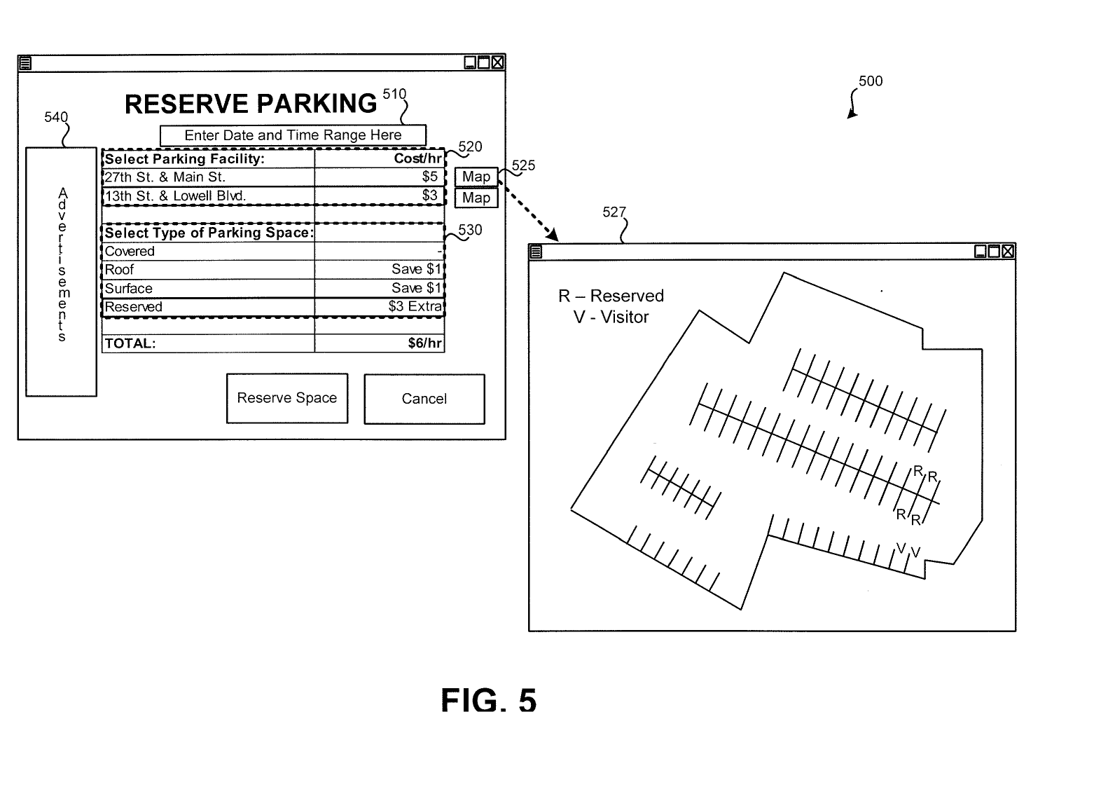

FIG. 5 illustrates another embodiment of a parking system graphical user interface 500. Parking system graphical user-interface 500 may be used by a day user to reserve a parking space remotely. For example, parking system graphical user interface 500 may be accessed from a remote computer system or a mobile device via a day user such that the day user will be assured that when the day user arrives at the parking facility a parking space will be reserved for her vehicle. Parking system graphical user-interface 500 may allow the user to select a parking facility in region 520. Associated with each parking facility may be a rate (which may be per hour, per day, or per some other time period). Additionally, the user may be able to specify a zone (in region 530) within a parking facility that she desires, such as a reserved parking space, a covered parking space, a rooftop parking space, surface parking space, etc. The type of parking space reserved by the user may result in the rate associated with parking at the parking facility varying. In some embodiments, some or all parking facilities may permit a user to select a particular parking space. For example, selecting map button 520 may display map 527 of the associated parking facility. The day user may then select the parking spot that the day user wishes to reserve. Unavailable parking spaces (e.g., parking spaces already occupied or already reserved) may be indicated as such on the map.

The user may also be required to enter a date and a time range (in region 510) in which she intends to park. Based upon characteristics of the user, possibly including information such as the date and time range entered in the parking facility selected, one or more advertisements (in region 540) may be displayed to the user. These advertisements may be targeted to the user based on the user's characteristics. As those with skill in the art will recognize, the various regions of parking system graphical user-interface 500 may be reconfigured. Further, more or less information may be requested from users to reserve a parking space in a parking facility.

The illustrated embodiment of parking system graphical user interface 500 of FIG. 5 is merely an example. The format in which information is collected from a user and presented to the user may vary. Multiple graphical user interfaces may be used to collect and/or present similar information. In some embodiments, additional or less information is presented to and/or collected from users reserving parking.

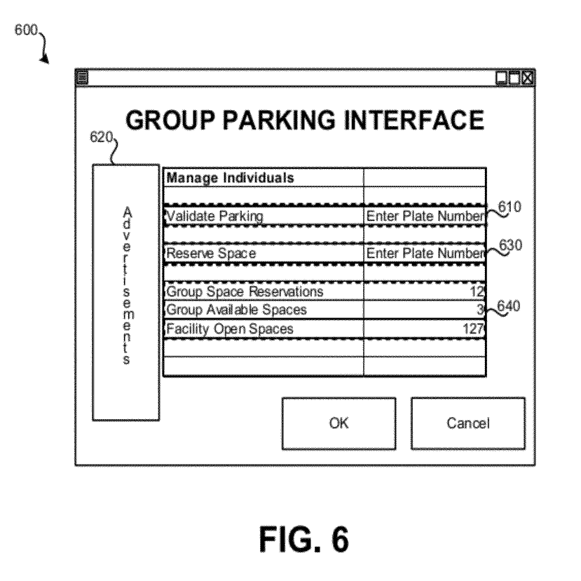

FIG. 6 illustrates an embodiment of a parking system graphical user interface 600. Parking system graphical user interface 600 may permit an entity, such as a tenant, to manage a group of one or more parking spaces leased from a parking facility via a parking management server. For example, parking system graphical user interface 600 may be presented to a user by tenant computer system, such as group tenant computer system 280 and communicate with a parking management server such as parking management server 110 of FIGS. 1 and 2.

In region 610, a group tenant (or other entity that wishes to pay for parking of a person with a vehicle in a parking facility) may be able to validate parking. This may be used for a guest parking in a parking facility in communication with the parking management server. By validating parking for a vehicle, such as by entering a vehicle identifier of the vehicle or a user name that the guest has established with the parking management server, the tenants may be billed for any parking fees incurred by the vehicle within the parking facility. In region 630, if a group tenant (or other entity) wishes to reserve a parking space for a vehicle, the tenant may be permitted to enter a vehicle identifier, such as a license plate number, or a username, and reserve a parking space. As such, the parking management server may regulate access to the parking facilities such that a space is reserved for the vehicle linked with the vehicle identifier (and user name) provided by the tenant.

Additionally, in region 640, information regarding parking spaces within the parking facility may be provided to the group tenant. For example, the number of spaces reserved for the group tenant may be displayed. The number of these parking spaces currently unoccupied may be displayed. Further the total number of available parking spaces within the parking facility may be displayed. In some embodiments, a map of the parking facility may be displayed, which may show available parking spaces and/or the parking spaces allotted to the group tenant.

Further, if various persons (e.g., employees, vendors) linked with the group tenant have access to the group tenant's parking spaces, access by these persons may be regulated via the group party interface. For example, by adding or deleting either usernames and/or vehicle identifiers, the group tenant may be able to control access to its group parking spaces. One or more advertisements 620 that are directed to the group tenant may be displayed by parking system graphical user interface 600.

The illustrated embodiment of parking system graphical user interface 600 of FIG. 6 is merely an example. The format in which information is collected from a user and presented to the user may vary. Multiple graphical user interfaces may be used to collect and/or present similar information. In some embodiments, additional or less information is presented to and/or collected from group tenants.

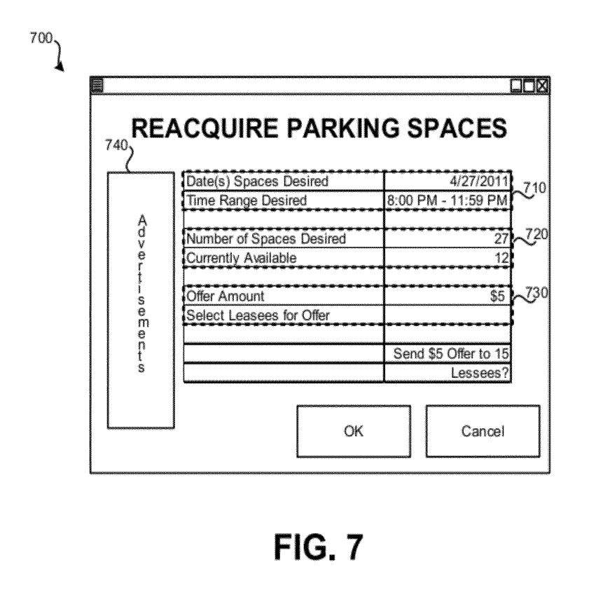

FIG. 7 illustrates an embodiment of a parking system graphical user interface 700. Parking system graphical user interface 700 may allow a manager to reacquire the rights to parking spaces within a parking facility. A manager using parking facility management computer system 130 may communicate with parking management server 110 using parking system graphical user interface 700. In region 710, the manager may specify the date or dates on which parking spaces are desired to be reacquired. The manager may also specify a time range over which the manager wishes to reacquire the parking spaces. In region 720, the manager may specify the number of parking spaces that the manager desires to reacquire. In region 730, the manager may specify an amount of money (or other consideration) to offer lessees for temporary use of the lessees' parking spaces. The manager may also have the option of selecting specific lessees who are to receive the offer. In region 740, one or more advertisements directed to the manager of the parking facility may be displayed.

When the manager submits the offer to the parking management server, the parking management server may contact the lessees until the number of spaces desired by the manager have been obtained. For example, if 27 spaces are desired by the manager, the offer may be initially submitted to 27 lessees. The lessees who initially receive the offer may be selected by the parking management server. For example, lessees may have an option of selecting whether they are to receive such offers or not. If 15 lessees reply that they are not interested in the offer, or a period of time elapses without a response from the lessees, 15 additional lessees may be presented with the offer. In some embodiments, the offer is presented to all lessees. However, the offer may only be accepted by those lessees (in this example, 27 lessees) first to respond.

The illustrated embodiment of parking system graphical user interface 700 of FIG. 7 is merely an example. The format in which information is collected from a manager and presented to the manager may vary. Multiple graphical user interfaces may be used to collect and/or present similar information. In some embodiments, additional or less information is presented to and/or collected from managers reacquiring parking spaces. While above example details reacquiring parking spaces from individuals, a manager may also be able to reacquire rights from group tenants.

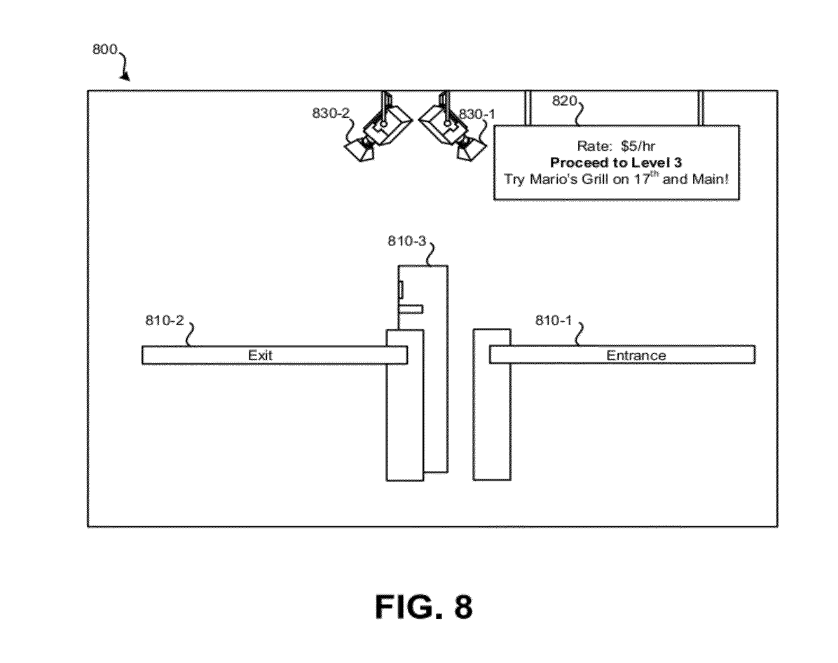

FIG. 8 illustrates an embodiment of a parking facility access system 800. Parking facility access system 800 may represent parking facility access system 120-1 of FIG. 2. Parking facility access system 800 may include: access control system 810, electronic signage/dynamic advertisements 820, and LPR cameras 830. Access control system 810 may include gate 810-1, gate 810-2, and pay station 810-3. Upon a vehicle pulling up to entrance gate 810-1, a camera 830-1 of an LPR system may detect the license plate number of the vehicle. Based upon the license plate number of the vehicle, as analyzed by a parking management server, access may or may not be granted to the parking facility. In parking facility access system 800, the electronic signage displaying the rate of the parking facility and the dynamic advertisement display are combined. Electronic signage/dynamic advertisements 820 may display advertisements, rate information, and/or directions to the parking area where a user is to park the user's vehicle. Upon exit from the parking facility, exit gate 810-2 may prevent exit by a vehicle until either payment is made using pay station 810-3 or camera 830-2 detects the license plate number of the vehicle attempting to exit and receives authorization from a parking management server to permit exit of the vehicle without payment being received by pay station 810-3.

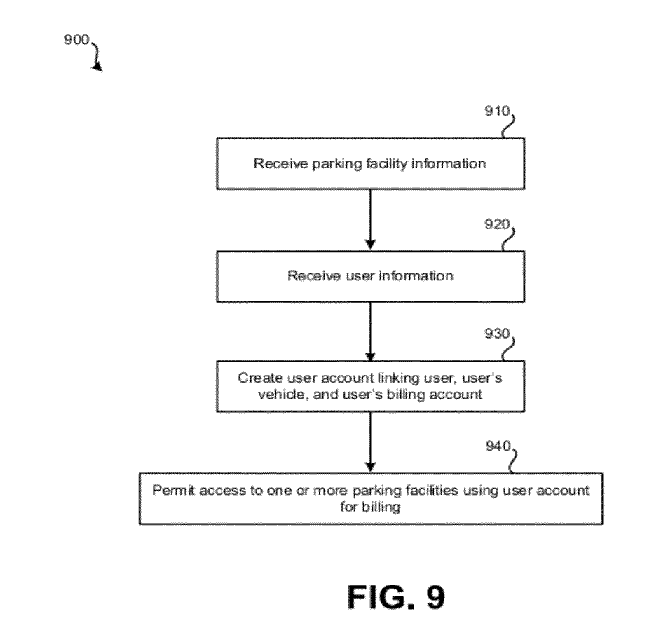

The various systems and graphical user interfaces previously described may be used to perform various methods. FIG. 9 illustrates an embodiment of a method 900 for creating a user account for a parking management system. Method 900 may be performed using a parking management system, such as parking management system 100 of FIG. 1 or parking management system 200 of FIG. 2. Other forms of parking management system may also be used to perform method 900.

At stage 910, a parking management server, such as parking management server 110 of FIGS. 1 and 2, may receive information about one or more parking facilities. Information on one or more parking facilities may be received by the parking management server from a parking facility management computer system, such as parking facility management computer system 130 of FIGS. 1 and 2. The information received regarding each parking facility may contain sufficient information for the parking management server to control access to the parking facility. For example, information regarding the number of parking spaces within the parking facility may be received. Additional information that may be received by the parking management server may include: the location of the parking facility (e.g., an address); the number of different types of parking spaces available within the parking facility (e.g., the number of rooftop spaces, the number of reserve spaces, number of non-reserved spaces); lease information on parking spaces within the parking facility; a map of the parking facility; etc.

At stage 920, user information may be received by the parking management server. The user information received may be sufficient to establish an account for a new user. For example, information which may be received includes: contact information (including the user's name, address, city, state, zip code, e-mail address, cell phone number, alternative phone number, company name, an indication of whether the user is linked with a tenant in a building associated with the parking facility, whether the user has a building access device, an identifier linked with the building access device, a driver's license number, a driver's license expiration date, and the state issuing the driver's license), vehicle information (including the number of vehicles the user wishes to register, the license plate number, the make, model, year, and color for each vehicle to be registered), billing information (including company contact information, a billing address, city, state, zip code, e-mail address, cell phone number, and an alternative phone number), the type of parking access desired (including a zone of the parking facility, and a number of parking spaces), a type of account (such as individual or group). In some embodiments, only some of this information is required and/or received. Additional information may also be received. For instance, a user who will be leasing a parking space may be required to provide more information than a day user registering to be a day user.

At stage 930, a user account may be created based on information received at stage 920. This user account may serve to link fees incurred as parking facilities linked with the parking management server to the appropriate user account. As such, if the vehicle enters and/or exits a parking facility linked with the parking management server, the parking management server may be configured to use an identifier of the vehicle, such as a license plate number, to identify a user account linked with the vehicle. If an associated user account is located, payment at the parking facility may not be required. Rather, the user's account may be billed for the parking fees incurred by the vehicle. Because a parking management server may be in communication with parking access control systems at multiple parking facilities, a user account may be billed for parking at parking facilities owned by different entities. As such, having an account with the parking management server may allow the user to park the vehicle that many parking facilities owned by different entities nationwide (or even worldwide). Further, if license plate numbers are used as a vehicle identifier, no additional hardware, such as RFID tag or a sticker (which may display a barcode or other machine-readable code), may need to be installed on the vehicle that is to use the parking facilities.

At stage 940, when the vehicle enters and/or exits a parking facility linked with the parking management server, access may be allowed without any input from the operator of the vehicle. For example, the license plate number of the vehicle may be acquired by a license plate recognition system upon entrance and exit and transmitted to the parking management server. Parking fees may be charged to the user account linked with the vehicle identifier upon the vehicle exiting the parking facility. Upon exiting the parking facility, electronic signage may be used to display to the operator of the vehicle the amount of parking fees incurred that are being charged to the user account.

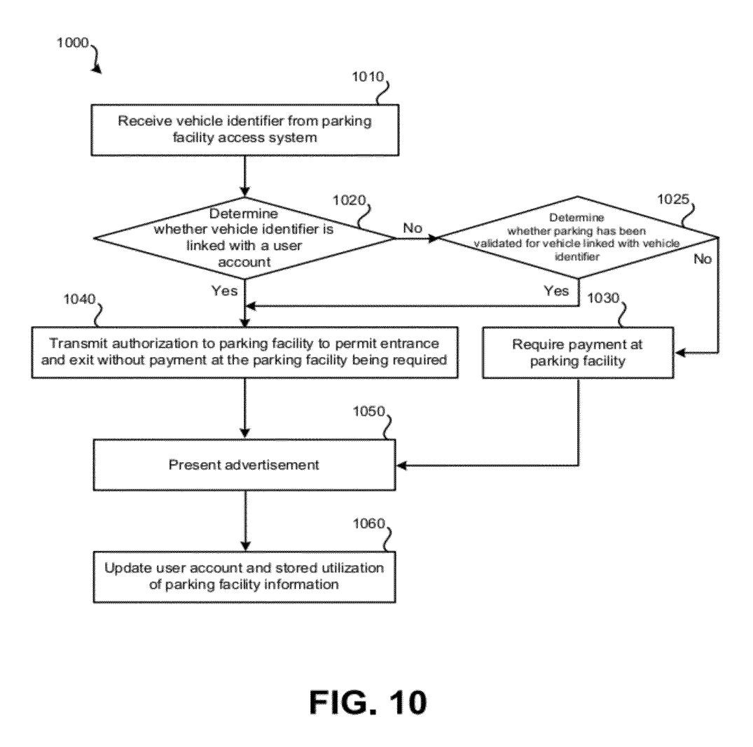

FIG. 10 illustrates an embodiment of a method for permitting use of a parking facility without requiring payment to be provided at the parking facility. Method 1000 may be performed using a parking management system, such as parking management system 100 of FIG. 1 or parking management system 200 of FIG. 2. Some other form of parking management system may also be used to perform method 1000.

At stage 1010, the vehicle identifier may be received by a parking management server from a parking facility access system. This may occur when a vehicle attempts to enter and/or exit the parking facility. If the parking facility access system uses license plate recognition, the vehicle identifier may be a license plate number. Referring to the parking management system 200 of FIG. 2, if the vehicle is at the parking facility of parking facility access system 120-1, LPR system 230-1 may capture the license plate number of the vehicle. The license plate number to be transferred to computer system 270-1. Computer system 270-1 may transfer the license plate number to parking management server 110. In other embodiments, the vehicle identifier may be linked with an RFID tag.

At stage 1020, the parking management server may determine whether the vehicle identifier received at stage 1010 is linked with a user account. This may involve the parking management server searching a user database to determine if the received vehicle identifier matches a vehicle identifier on record that is linked with a user account. If not, at stage 1025, it may be determined whether parking has been validated, such as by a group tenant, for the vehicle linked with the vehicle identifier. If not, payment may be required to be made at the parking facility at 1030. Payment at the parking facility may require a person to make either a cash or credit transaction at a pay station, such as pay station 810-3 of FIG. 8. Despite no user account being linked with the vehicle identifier, an LPR system may be used to track the amount of time the vehicle has spent within the parking facility. As such, no ticket or card may need to be issued to the operator of the vehicle upon entrance to the parking facility. Similarly, no ticket may need to be produced by the vehicle's operator to the pay station upon exit of the parking facility. Rather, the pay station may indicate the amount of time spent by the vehicle in the parking facility and require payment of associated parking fees.

If the vehicle identifier is determined to be linked with the user account at stage 1020, or the parking for the vehicle linked with the vehicle identifier has been determined to be validated at stage 1025, method 1000 may proceed to stage 1040. At stage 1040, the parking management server may transmit authorization to the parking facility that indicates access (entrance and exit) is permitted without payment being required at the parking facility. For example, the parking management server may transmit an indication to the parking facility access system of the parking facility that instructs an access control system to permit the vehicle entrance and/or exit from the parking facility. This may involve raising one or more gates.

At stage 1050, an advertisement, such as via a dynamic advertisement display, may be presented to the operator of the vehicle upon entrance and/or exit from the parking facility. If the vehicle is linked with the user account, the one or more advertisements displayed may be targeted to characteristics of the user account. If little information is known about the operator of the vehicle, such as if the operator of the vehicle is not linked to a user account, the advertisement may be based on characteristics external to the operator of the vehicle, such as the time of day, day of week, the weather, etc.

At stage 1060, likely upon the vehicle exiting the parking facility, the user account (if present) may be updated. This may involve modifying the user account to reflect the parking fees incurred at the parking facility. This may also involve billing the parking fees to a billing account on record in the user account. Information regarding the parking fees may be stored and linked with the user account such that at a later time the user can retrieve previously billed parking fees for review. Additionally, at stage 1060, utilization information may be updated for the parking facility. As such, information displayed via a parking facility management computer system, such as dashboard 300 of FIG. 3, may be updated.

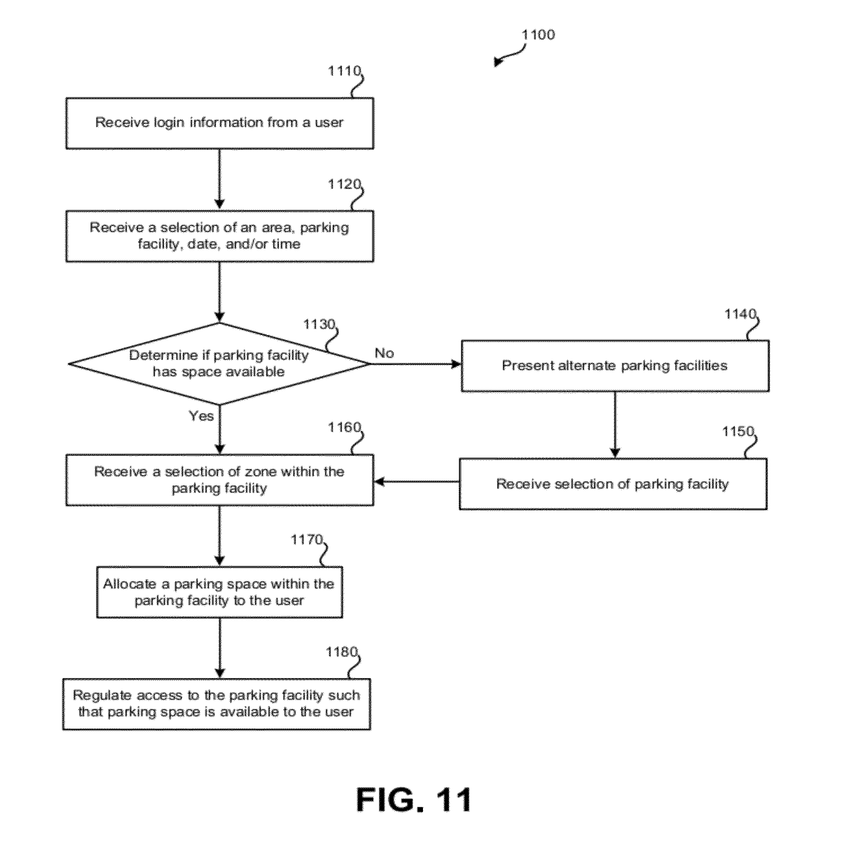

FIG. 11 illustrates an embodiment of a method for reserving a parking space for a user remotely, such as from a remote computer system or a mobile device, such as a cellular phone. Method 1100 may be performed using a parking management system, such as parking management system 100 of FIG. 1 or parking management system 200 of FIG. 2. Some other form of parking management system may also be used to perform method 1100. The user who desires to reserve a parking space may be a day user for the parking facility at which she intends to reserve a parking space. In some embodiments, a lessee may be permitted to reserve a specific parking space at a parking facility where the lessee holds a lease for a parking space remotely.

At stage 1110, login information may be received from a user. As such, a user may have previously established a user account with a parking management server. Login information may include a username and password. In some embodiments, alternative information is presented by the user for login. If a person does not have a user account, a method, such as method 900 of FIG. 9, may be used to create a user account for the person.

At stage 1120, assuming the login information provided by the user is correct, the user may be granted access to her account. A graphical user interface, such as parking system graphical user interface 500 of FIG. 5, may be presented to the user. The user may provide a selection of an area in which the user desires to park and/or a specific parking facility. The user may also provide a date and/or time at which she intends on entering and/or exiting the parking facility. If the parking space is unused for a portion of the reserved time period, the user may or may not be charged associated parking fees.

At stage 1130, the parking server system may determine whether the parking facility (or a parking facility in the area) requested by the user will have space available for the requested date and/or times. If not, the method may proceed to stage 1140. At stage 1140, the user may be presented with alternative parking facilities that are in communication with the parking management server and are near the area or parking facility requested by the user. At stage 1150, the user may select an alternative parking facility from the list or map of facilities presented by the parking management server. Returning to stage 1130, if the parking facility or parking facility within the area is selected by the user and has a parking space available, method 1100 may proceed to stage 1160.

At stage 1160, a selection of a zone within the parking facility may be received from the user. In some embodiments, the user may not have the opportunity to select a zone within the parking facility. If the user is presented an opportunity to select a zone within the parking facility, the user may have the opportunity to select zone such as rooftop parking, surface parking, and unreserved parking and/or reserved parking. The price for each type of parking space may vary. In some embodiments, the user may select a specific parking spot. To select a parking spot or zone, a map of the parking facility may be presented to the user.

At stage 1170, a parking space within the parking facility (and the selected zone) may be allocated to the user. As such, the user may be assured that upon arrival at the parking facility a parking space within the facility and requested zone is available. At stage 1170, parking facility utilization information may also be updated. Since a parking space has been allocated to the user, access to the parking facility may be regulated by the parking management server (at stage 1180) such that a space is held available for the date and time range received from the user. Such regulation may involve denying access to other vehicles to the parking facility despite a parking space being empty (because the space is reserved for the user). For instance, the vehicle may be denied by a gate of an access control system not being raised.

However, upon arrival by the vehicle of the user, the vehicle identifier of the user's vehicle may be used to identify the user account of the user. The user account may reflect that a space within the parking facility has been reserved for the user. If the time and date range at which the user and the user's vehicle is attempting to enter the parking facility at least approximately match, the user and the user's vehicle may be granted access to the parking facility such that the space reserved remotely may be accessed and used by the user. Electronic signage may indicate a parking space number, level, or zone of the parking facility that the user is to proceed to.

FIG. 12 illustrates an embodiment of providing users in a queue the opportunity to acquire a parking space. Method 1200 may be performed using a parking management system, such as parking management system 100 of FIG. 1 or parking management system 200 of FIG. 2. Some other form of parking management system may also be used to perform method 1200.

Some parking facilities may be expected to have a high demand for leased parking spaces. As such, the number of requests for leased parking spaces may exceed the number of parking spaces available for lease. As such, maintaining a queue such that potential lessees are contacted by the parking management server as parking spaces become available may be beneficial.

At stage 1210, the parking management server may receive an indication that a parking space is available for lease. This may occur if a previous lessee (such as an individual or a group tenant) has terminated or not renewed a lease or the manager of the parking facility has allocated an additional parking space for leasing (such as by decreasing the number of parking spaces allocated for day users).

At stage 1220, a user in a queue may be identified. Previously, a user may have added herself to the queue by attempting to lease a parking space, such as using parking system graphical user interface 400 of FIG. 4. Information provided by the user to enter the queue may include: the user's name, the date the user would like to lease a parking space, and a phone number that accepts text messages. The user that has been in the queue the longest may be identified.

At stage 1230, a message may be transmitted to the user. The message may be in a form such as an email, text message (to a mobile device), or phone call and may be received by the user via a mobile device, computer system, or telephone. The user may have a certain amount of time to respond in the affirmative that the user still desires to lease the parking space. For example, the user may be allowed 48 hours to respond before another user is contacted.

At stage 1240, if the user indicates that the user wants the parking space, the method may proceed to stage 1250 to complete the lease for the parking space by the user. Terms and conditions of the lease may be transmitted to the user, which may require the user's signature. If the user does not want the parking space, the queue may be updated at stage 1260 (such as by removing the user who responded at stage 1240 or by moving the user to the back of the queue). Method 1200 may return to stage 1220 to identify the next user in the queue. Method 1200 may repeat until a user accepts a lease for the parking space.

FIG. 13 illustrates an embodiment of a computer system. A computer system as illustrated in FIG. 13 may incorporate as part of the previously described computerized devices. For example, computer system 1300 can represent some of the components of the mobile devices and/or the remote computer systems discussed in this application. FIG. 13 provides a schematic illustration of one embodiment of a computer system 1300 that can perform the methods provided by various other embodiments, as described herein, and/or can function as the parking management server, parking facility management computer system, mobile device, remote computer system, tenant computer system, and/or the computer system of the parking facility access systems. It should be noted that FIG. 13 is meant only to provide a generalized illustration of various components, any or all of which may be utilized as appropriate. FIG. 13, therefore, broadly illustrates how individual system elements may be implemented in a relatively separated or relatively more integrated manner.

The computer system 1300 is shown comprising hardware elements that can be electrically coupled via a bus 1305 (or may otherwise be in communication, as appropriate). The hardware elements may include one or more processors 1310, including without limitation one or more general-purpose processors and/or one or more special-purpose processors (such as digital signal processing chips, graphics acceleration processors, and/or the like); one or more input devices 1315, which can include without limitation a mouse, a keyboard and/or the like; and one or more output devices 1320, which can include without limitation a display device, a printer and/or the like.

The computer system 1300 may further include (and/or be in communication with) one or more non-transitory storage devices 1325, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 1300 might also include a communications subsystem 1330, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 1330 may permit data to be exchanged with a network (such as the network described below, to name one example), other computer systems, and/or any other devices described herein. In many embodiments, the computer system 1300 will further comprise a working memory 1335, which can include a RAM or ROM device, as described above.

The computer system 1300 also can comprise software elements, shown as being currently located within the working memory 1335, including an operating system 1340, device drivers, executable libraries, and/or other code, such as one or more application programs 1345, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1325 described above. In some cases, the storage medium might be incorporated within a computer system, such as the system 1300. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 1300 and/or might take the form of source and/or installable code, which, upon compilation and/or installation on the computer system 1300 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 1300) to perform methods in accordance with various embodiments of the invention. According to a set of embodiments, some or all of the procedures of such methods are performed by the computer system 1300 in response to processor 1310 executing one or more sequences of one or more instructions (which might be incorporated into the operating system 1340 and/or other code, such as an application program 1345) contained in the working memory 1335. Such instructions may be read into the working memory 1335 from another computer-readable medium, such as one or more of the storage device(s) 1325. Merely by way of example, execution of the sequences of instructions contained in the working memory 1335 might cause the processor(s) 1310 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 1300, various computer-readable media might be involved in providing instructions/code to processor(s) 1310 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 1325. Volatile media include, without limitation, dynamic memory, such as the working memory 1335.

Common forms of physical and/or tangible computer-readable media are non-transitory and include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 1310 for execution. Merely by way of example, the instructions may initially be carried on a magnetic disk and/or optical disc of a remote computer. A remote computer might load the instructions into its dynamic memory and send the instructions over a transmission medium to be received and/or executed by the computer system 1300.

The communications subsystem 1330 (and/or components thereof) generally will receive the signals, and the bus 1305 then might carry the signals (and/or the data, instructions, etc. carried by the signals) to the working memory 1335, from which the processor(s) 1305 retrieves and executes the instructions. The instructions received by the working memory 1335 may optionally be stored on a storage device 1325 either before or after execution by the processor(s) 1310.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

What is claimed is:

1. A method for managing parking facilities, the method comprising:
receiving, by a computer system, information regarding a plurality of parking facilities, wherein the information regarding each parking facility comprises:
a number of parking spaces in the parking facility; and
a location of the parking facility;
receiving, by the computer system, a vehicle identifier and identification of a user, wherein:
the vehicle identifier comprises a license plate number;
creating, by the computer system, a user account linked with the vehicle identifier, the vehicle, and the user, wherein the user account is configured to:
link parking fees sustained by the vehicle at the plurality of parking facilities with the user account; and
permit the vehicle access to the plurality of parking facilities using the vehicle identifier wherein payment is not required to be made at the plurality of parking facilities.

2. The method for managing parking facilities of claim 1, further comprising:
transmitting, by the computer system, to a parking facility management computer system, parking utilization information for at least one parking facility of the plurality of parking facilities.

3. The method for managing parking facilities of claim 1, further comprising:
receiving, by the computer system, from a remote computer system, a selection of a parking facility from the plurality from parking facilities, wherein:
the selection is linked with the user account; and
allocating, by the computer system, a parking space within the parking facility to the vehicle linked with the user account, wherein:
access to the parking facility is regulated to reserve the parking space for the vehicle linked with the user account.

4. The method for managing parking facilities of claim 3, further comprising:
receiving, by the computer system, from the remote computer system, a selection of a zone within the parking facility, wherein allocating the parking space within the parking facility to the vehicle comprises allocating the parking space within the zone of the parking facility to the vehicle.

5. The method for managing parking facilities of claim 1, further comprising:
storing, by the computer system, an indication of a lease agreement linked with the user account, wherein:
the lease agreement requires reservation of a parking space at a parking facility of the plurality of parking facilities for the vehicle linked with the user account;
receiving, by the computer system, a request to acquire access to the parking space for a period of time;
transmitting, by the computer system, to a mobile device linked with the user account, an offer to the user linked with the user account for the parking space for the period of time; and
receiving, by the computer system, from the mobile device, a response to the offer.

6. The method for managing parking facilities of claim 1, further comprising:
transmitting, by the computer system, to a remote computer system, information identifying multiple available parking spaces in multiple parking facilities of the plurality of parking facilities.

7. A method for controlling access to a parking facility, the method comprising:
receiving, by a computer system, from a parking facility access system of the parking facility, a vehicle identifier, wherein:
the vehicle identifier comprises a license plate number;
determining, by the computer system, whether the vehicle identifier is linked with a user account;
transmitting, by the computer system, an authorization to the parking facility access system, wherein the authorization permits the vehicle access to and from the parking facility without requiring payment to be made at the parking facility; and
updating, by the computer system, stored information regarding utilization of the parking facility.

8. The method for controlling access to the parking facility of claim 7, further comprising:
receiving, by the computer system, from a remote computer system, a selection of the parking facility, wherein:
the selection is linked with the user account; and
allocating, by the computer system, a parking space within the parking facility to the vehicle linked with the user account, wherein:
access to the parking facility is regulated to reserve the parking space for the vehicle linked with the user account.

9. The method for controlling access to the parking facility of claim 8, further comprising:
receiving, by the computer system, from the remote computer system, a selection of a zone within the parking facility, wherein allocating the parking space within the parking facility to the vehicle comprises allocating the parking space within the zone of the parking facility to the vehicle.

10. The method for controlling access to the parking facility of claim 7, further comprising:
receiving, by the computer system, from a third party remote computer system, the vehicle identifier and a request to pay parking fees for the vehicle linked with the vehicle identifier incurred at the parking facility.

11. The method for controlling access to the parking facility of claim 7, further comprising:
receiving, by the computer system, information regarding the parking facility, wherein the information regarding the parking facility comprises:
a number of parking spaces in the parking facility; and
a location of the parking facility;
receiving, by the computer system, the vehicle identifier and identification of a user;
creating, by the computer system, the user account linked with the vehicle identifier, the vehicle, and the user, wherein the user account is configured to:
link parking fees sustained by the vehicle at the parking facility with the user account; and
permit the vehicle access to the parking facility without requiring payment to be made at the parking facility, wherein permission is at least partially based on the vehicle identifier.

12. The method for controlling access to the parking facility of claim 11, further comprising:
storing, by the computer system, an indication of a lease agreement linked with the account and vehicle identifier, wherein the lease agreement requires reservation of a parking space at the parking facility for the vehicle linked with the user account;
receiving, by the computer system, a request to acquire access to the parking space for a period of time;
transmitting, by the computer system, an offer to the user linked with the user account for the parking space for the period of time; and
receiving, by the computer system, a response to the offer from the user linked with the user account.

13. The method for controlling access to the parking facility of claim 7, further comprising:
causing, by the computer system, on the remote computer system, an advertisement to be displayed, wherein:
the advertisement is at least partially based on parking characteristics of the vehicle linked with the user account; and
the parking characteristics comprise time of day and day of week information.

14. A system for managing a parking facility, the system comprising:
a computer system, configured to:
receive information regarding a plurality of parking facilities, wherein the information for each parking facility comprises:
a number of parking spaces; and
a location;
receive, from a remote computer system, a vehicle identifier, wherein:
the vehicle identifier is sufficient to identify a vehicle;
create a user account linked with a user, the vehicle identifier, and the vehicle, wherein the user account is configured to:
link parking fees sustained at the plurality of parking facilities with the user account, wherein the parking fees are sustained by the vehicle;
receive from a parking facility access system of a parking facility, the vehicle identifier;
determine whether the vehicle identifier is linked with a user account;
transmit an authorization to the parking facility access system, wherein:
the authorization indicates that the vehicle is permitted access to and from the parking facility without requiring payment to be made at the parking facility.

15. The system for managing the parking facility of claim 14, the system further comprising:
the parking facility access system, comprising a license plate recognition system and an access control system, wherein the parking facility access system is configured to:
transmit the vehicle identifier to the computer system, wherein:
the vehicle identifier comprises a license plate number; and
the computer system is remote from the parking facility access system;
receive the authorization that indicates the vehicle is permitted to use the parking facility without requiring payment to be made at the parking facility; and
permit access, via the access control system, to and from the parking facility by the vehicle.

16. The system for managing the parking facility of claim 14, the system further comprising:
a parking facility management computer system, configured to:
receive real time utilization information from the computer system; and
provide lease information regarding a plurality of leases of parking spaces within the parking facility.

17. The system for managing the parking facility of claim 14, the system further comprising:
a remote computer system, configured to:
request allocation of a parking space within the parking facility for the vehicle linked with the user account.

18. The system for managing the parking facility of claim 14, the system further comprising:
a dynamic advertisement display, located at the parking facility, linked with the computer system, wherein:
the dynamic advertisement display is configured to display advertisements based on parking characteristics of the vehicle when the user is expected to be in the vicinity of the dynamic advertisement display.

19. The system for managing the parking facility of claim 14, the system further comprising:
a mobile device, configured to:
receive offers regarding a parking space leased by the user from the computer system; and
transmit responses to the offers received to the computer system.

20. The system for managing the parking facility of claim 14, the system further comprising:
electronic signage visible near an entrance to the parking facility, wherein the electronic signage is configured to display rates as received from the computer system.
